(19) United States
(12) Patent Application Publication
(10) Pub. No.: US 2025/0067368 A1
(43) Pub. Date: Feb. 27, 2025

(54) MODULAR TUBE MANAGEMENT SYSTEM

(71) Applicant: Shine Technologies, LLC, Janesville, WI (US)

(72) Inventor: James Davidson, Janesville, WI (US)

(21) Appl. No.: 18/813,169

(22) Filed: Aug. 23, 2024

Related U.S. Application Data
(60) Provisional application No. 63/534,511, filed on Aug. 24, 2023.

(51) Int. Cl. F16L 3/26; G01N 30/00

(52) U.S. Cl. CPC F16L 3/26; G01N 30/00

(57) ABSTRACT

An assembly including a first elbow with a first channel formed therein, a second elbow with a second channel formed therein, and a third elbow. The first elbow, the second elbow, and the third elbow are stacked along an axis, and the second elbow is positioned between the third elbow and the first elbow. The first elbow includes a first pin, the second elbow includes a first socket, and the first pin is positioned within the first socket. The second elbow includes a second pin, the third elbow includes a second socket, and the second pin is positioned within the second socket. The first channel is configured to at least partially receive a first tube and the second channel is configured to at least partially receive a second tube.

### CROSS-REFERENCE TO RELATED APPLICATIONS

This application claims the benefit of U.S. Provisional Application No. 63/534,511 filed on Aug. 24, 2023, which is incorporated herein by reference in its entirety.

### TECHNOLOGY

The present disclosure is generally related to tube routing and management. More particularly, the present disclosure is directed to devices for routing tubes in a chromatography assembly, for example, within a hot cell.

### BACKGROUND

Ytterbium-176 (Yb-176), when irradiated, generates Lutiteum-177 (Lu-177). Lu-177 is a radioisotope that is used in the treatment of neuro endocrine tumors, prostate, breast, renal, pancreatic, and other cancers. In the coming years, approximately 70,000 patients per year will need Lu-177 during their medical treatments.

Once Yb-176, for example, has been irradiated, the irradiated target can only be handled by manipulators within a hot cell (e.g., an appropriately radiation-shielded enclosure). This makes it difficult to manipulate and organize systems that further process the irradiated target within the hot cell (e.g., a chromatography system). Accordingly, a need exists for improved organization of processing systems for use in high radiation environments.

### SUMMARY

According to a first aspect of the present disclosure, a tube elbow comprising: a first surface; a second surface; a third surface extending between the first surface and the second surface; a channel formed in the first surface, the channel extends through the third surface; a socket formed in the first surface; and a pin extending from the second surface; wherein the channel is configured to at least partially receive a tube.

A second aspect includes the tube elbow of the first aspect, wherein the channel is arcuate.

A third aspect includes the tube elbow of the first aspect or the second aspect, further comprising an aperture extending through the first surface and the second surface.

A fourth aspect includes the tube elbow of any of the previous aspects, wherein the channel is positioned between the aperture and the socket.

A fifth aspect includes the tube elbow of any of the previous aspects, further comprising a fourth surface extending between the first surface and the second surface; wherein the fourth surface is arcuate, and the third surface is planar.

A sixth aspect includes the tube elbow of any of the previous aspects, wherein the channel is one of a plurality of channels formed in the first surface.

A seventh aspect includes the tube elbow of any of the previous aspects, wherein the channel has a span in a range of from 90 degrees to 180 degrees.

An eighth aspect includes the tube elbow of any of the previous aspects, further comprising a fourth surface extending between the first surface and the second surface; and a fifth surface extending between the first surface and the second surface, wherein the channel extends through the fifth surface.

A ninth aspect includes the tube elbow of any of the previous aspects, wherein the fifth surface is planar.

A tenth aspect includes the tube elbow of any of the previous aspects, wherein the channel has a span of 180 degrees and extends through the third surface at a first location and at a second location.

According to an eleventh aspect of the present disclosure, an assembly comprising a first elbow with a first channel formed therein; a second elbow with a second channel formed therein; and a third elbow; wherein the first elbow, the second elbow, and the third elbow are stacked along an axis, and the second elbow is positioned between the third elbow and the first elbow; wherein the first elbow includes a first pin, the second elbow includes a first socket, the first pin is positioned within the first socket; wherein the second elbow includes a second pin, the third elbow includes a second socket, the second pin is positioned within the second socket; and wherein the first channel is configured to at least partially receive a first tube and the second channel is configured to at least partially receive a second tube.

A twelfth aspect includes the assembly of the eleventh aspect, the first channel is arcuate and the second channel is arcuate.

A thirteenth aspect includes the assembly of the eleventh or twelfth aspects, wherein the first channel has a first span and the second channel has a second span that is different than the first span.

A fourteenth aspect includes the assembly of any of the previous aspects, wherein the first span and the second span are each in a range of from 90 degrees and 180 degrees and the first span is greater than the second span.

A fifteenth aspect includes the assembly of any of the previous aspects, further comprising a first tube at least partially positioned in the first channel and a second tube at least partially positioned in the second channel.

A sixteenth aspect includes the assembly of any of the previous aspects, wherein the first tube is a polymer tube and the second tube is a polymer tube.

An seventeenth aspect includes the assembly of any of the previous aspects, wherein the first channel is one of a first plurality of channels formed in the first elbow.

A eighteenth aspect includes the assembly of any of the previous aspects, wherein a surface of the first elbow at least partially encloses the second channel in the second elbow.

A nineteenth aspect includes the assembly of any of the previous aspects, wherein the first elbow includes a first aperture, the second elbow includes a second aperture, and the third aperture includes a third aperture; and wherein the first aperture, the second aperture, and the third aperture are aligned.

A twentieth aspect includes the assembly of any of the previous aspects, wherein the assembly is configured for operation within a radiation hot cell.

According to a twenty-first aspect of the present disclosure, a system comprising: a hot cell; a manipulator at least partially positioned within the hot cell; a chromatography assembly at least partially positioned within the hot cell, the chromatography assembly including a plurality of tubes; and a tube elbow positioned within the hot cell, wherein at least one of the plurality of tubes is coupled to the tube elbow.

A twenty-second aspect includes the system of the twenty-first aspect, wherein the tube elbow comprises: a first surface; a second surface; a third surface extending between the first surface and the second surface; a channel formed in the first surface, the channel extends through the third surface; a socket formed in the first surface; and a pin extending from the second surface; wherein the at least one of the plurality of tubes is nested in the channel.

A twenty-third aspect includes the system of the twenty-first or twenty-second aspect, wherein a radioisotope is present in the chromatography assembly.

A twenty-fourth aspect includes the system of any of the previous aspects, wherein the tube elbow is a first tube elbow and the system further comprises a second tube elbow, and wherein at least one of the plurality of tubes is coupled to the tube elbow.

A twenty-fifth aspect includes the system of any of the previous aspects, wherein the second tube elbow is mounted on the first tube elbow.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of a tube elbow with a channel configured to route a tube 90 degrees, according to one or more embodiments shown and described herein;

FIG. 2 is a perspective view of a tube elbow with a plurality of channels configured to route a plurality of tubes 90 degrees, according to one or more embodiments shown and described herein;

FIG. 3 is a perspective view of a tube elbow with a channel configured to route a tube 180 degrees, according to one or more embodiments shown and described herein;

FIG. 4 is a perspective view of a tube elbow with a plurality of channels configured to route a plurality of tubes 180 degrees, according to one or more embodiments shown and described herein;

FIG. 5 is a perspective view of an assembly including four tube elbows of FIG. 2, according to one or more embodiments shown and described herein;

FIG. 6 is a perspective view of an assembly include tube elbows of FIG. 1 and tube elbows of FIG. 3, according to one or more embodiments shown and described herein; and

FIG. 7 is a schematic of a hot cell including a chromatography system with a plurality of tubes routed with tube elbows, according to one or more embodiments shown and described herein.

### DETAILED DESCRIPTION

Lu-177 is used in the treatment of neuro endocrine tumors, prostate, breast, renal, pancreatic, and other cancers. In the coming years, approximately 70,000 patients per year will need no carrier added Lu-177 during their medical treatments. Lu-177 is useful for many medical applications, because during decay it emits a low energy beta particle that is suitable for treating tumors. It also emits two gamma rays that can be used for diagnostic testing. Isotopes with both treatment and diagnostic characteristics are termed “theranostic.” Not only is Lu-177 theranostic, but it also has a 6.65-day half-life, which allows for more complicated chemistries to be employed, as well as allowing for easy global distribution. Lu-177 also exhibits chemical properties that allow for binding to many bio molecules, for use in a wide variety of medical treatments.

There are two main production pathways to produce Lu-177. One is via a neutron capture reaction on Lu-176; Lu-176 (n,γ) Lu-177. This production method is referred to as carrier added (ca) Lu-177. A carrier is an isotope(s) of the same element (Lu-176 in this case), or similar element, in the same chemical form as the isotope of interest. In microchemistry the chemical element or isotope of interest does not chemically behave as expected due to extremely low concentrations. Moreover, isotopes of the same element cannot be chemically separated, and require mass separation techniques. The carrier method, therefore, results in the produced Lu-177 having limited medical application.

The second production method for Lu-177 is a neutron capture reaction on ytterbium-176 (Yb-176) (Yb-176 (n,γ) Yb-177) to produce Yb-177. Yb-177 then rapidly (t1/2 of 1.911 hours) beta-decays into Lu-177. An impurity of Yb-174 is typically present in the Yb-176, leading to a further impurity of Lu-175 in the final product. This process is considered a “no carrier added” process. The process may be carried out as ytterbium metal or ytterbium oxide. A phase change system may be used for the separation of ytterbium and lutetium obtained from a no carrier added process.

In some embodiments, the process may then also include further purification of the lutetium using a chromatographic separation process. In any of the above embodiments, the chromatographic separation may include column chromatography, plate chromatography, thin cell chromatography, or high-performance liquid chromatography.

These chromatography systems include a plurality of tubes that are strewn throughout the hot cell environment in which hot cell manipulators are expected to move and manipulate objects. In other words, the plurality of tubes create clutter in the hot cell where the hot cell manipulators need to operate. This causes issues such as, tube kinks, tube breaks, and unintentional disconnections.

Metal tubing (e.g., stainless steel tubing) can be bent and independently maintains the desired shape. In contrast, polymer tubes (e.g., polyether ether ketone (PEEK) tube, low density polyethylene (LDPE) tube) cannot be bent into a form that is independently maintained. As such, polymer tubes used in chromatography systems are especially difficult to route and organize.

Disclosed herein is a modular system for organizing fluidics tubes in an orderly fashion to facilitate operations, especially within a hot cell where ergonomics, mobility, and dexterity are challenged.

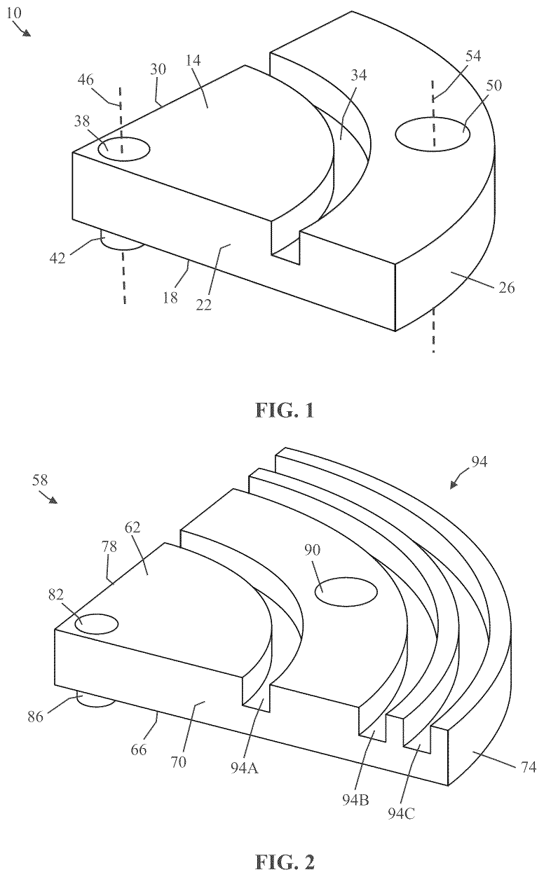

With reference to FIG. 1, a tube elbow 10 (e.g., an elbow) includes a first surface 14, a second surface 18, and a third surface 22 extending between the first surface 14 and the second surface 18. In the illustrated embodiment, the first surface 14 is planar and the second surface 18 is planar. In the illustrated embodiment, the second surface 18 is parallel to the first surface 14. In the illustrated embodiment, the third surface 22 is planar.

With continued reference to FIG. 1, the tube elbow 10 includes a fourth surface 26 extending between the first surface 14 and the second surface 18. In the illustrated embodiment, the fourth surface 26 is arcuate. The tube elbow 10 further includes a fifth surface 30 extending between the first surface 14 and the second surface 18. In the illustrated embodiment, the fifth surface 30 is planar. In the illustrated embodiment, the tube elbow 10 is a quarter-circle shaped plate.

With continued reference to FIG. 1, the tube elbow 10 includes a channel 34 formed in the first surface 14. As described in further detail herein, the channel 34 is configured to at least partially receive a tube (e.g., a polymer tube). In some embodiments, the channel 34 has a depth slightly greater than the outer diameter of the corresponding tubing the channel 34 receives. In some embodiments, the channel 34 depth is approximately 0.7 inches and is configured to receive 1/16 inch outer diameter PEEK tubing. In some embodiments, the channel 34 depth is in a range of from 0.6 inches to 0.8 inches. In some embodiments, the channel 34 depth is in a range of from 0.2 inches to 1.2 inches. In some embodiments, the channel 34 is configured to receive tubing with an outer diameter in a range of from 0.05 inches to 0.07 inches. In some embodiments, the channel 34 is configured to receive tubing with an outer diameter in a range of from 0.03125 to 0.125 inches. In some embodiments, the channel 34 is arcuate. In the illustrated embodiment, the channel 34 has a span of approximately 90 degrees. In other words, the channel 34 is a 90-degree bend. In some embodiments, the channel 34 has a span of less than 90-degrees. In some embodiments, the channel 34 has a span within a range of approximately 10 degrees to approximately 90 degrees. In the illustrated embodiment, the channel 34 extends through the third surface 22 and the channel 34 extends through the fifth surface 30.

With continued reference to FIG. 1, the tube elbow 10 includes a socket 38 formed in the first surface 14 and a pin 42 extending from the second surface 18. In the illustrated embodiment, the socket 38 is a blind hole with a diameter of approximately 0.13 inches and extends approximately 3/32 inches deep. In some embodiments, the socket 38 diameter is in a range of from 0.1 inches to 0.15 inches. In some embodiments, the socket 38 diameter is in a range of from 0.01 inches to 1.0 inch. In some embodiments, the socket 38 depth is in a range of from 0.06 inches to 0.125 inches. In some embodiments, the socket 38 depth is in a range of from 0.01 inches to 1.0 inch. In the illustrated embodiment, the pin 42 is cylindrical with a diameter of approximately 0.125 inches and extends from the second surface 18 approximately 1/16 inch. In some embodiments, the pin 42 diameter is in a range of from 0.095 inches to 0.120 inches. In some embodiments, the pin 42 diameter is in a range of from 0.005 inches to 0.995 inches. In some embodiments, the pin 42 extends a height in a range of from 0.029 inches to 0.094 inches. In some embodiments, the pin 42 extends a height in a range of from 0.069 inches to 0.969 inches. In the illustrated embodiment, the socket 38 is aligned with the pin 42 along an interconnect axis 46. In the illustrated embodiment, the interconnect axis 46 extends through the first surface 14 and the second surface 18. More specifically, in the illustrated embodiment, the interconnect axis 46 is perpendicular to the first surface 14 and the second surface 18. As detailed further herein, the pin 42 is sized to fit within the socket 38 of a second adjacent tube elbow 10. In other words, the pin 42 and socket 38 are aligned with each other and located on opposite sides of the tube elbow 10. In some embodiments, the pin and socket coupled together form an interference fit between two adjacent tube elbows.

With continued reference to FIG. 1, the tube elbow 10 includes an aperture 50 extending through the first surface 14 and the second surface 18. In other words, the aperture 50 expends through the tube elbow 10. As detailed further herein, the aperture 50 is configured to receive a fastener to secure the tube elbow 10 to the surrounding workspace. The aperture 50 defines an aperture axis 54. In the illustrated embodiment, the aperture axis 54 is spaced from and parallel to the interconnect axis 46. In the illustrated embodiment, the channel 34 is positioned between the aperture 50 and the socket 38. In other words, the aperture 50 is positioned radially outward from the channel 34, and the socket 38 is positioned radially inward from the channel 34.

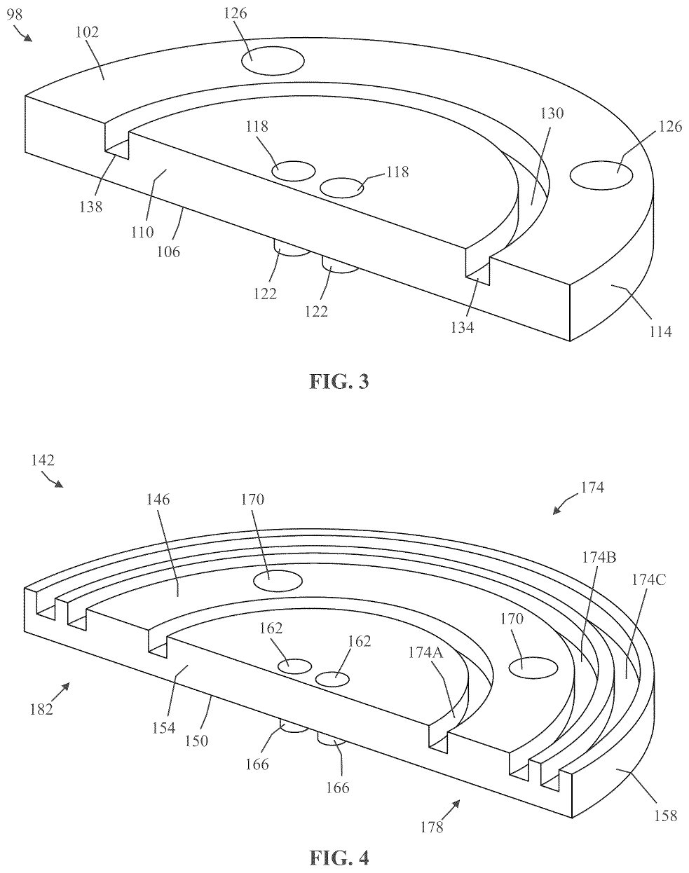

With reference to FIG. 2, a tube elbow 58 illustrated is similar to the tube elbow 10 and is detailed herein with similar terminology where possible. The tube elbow 58 includes a first surface 62, a second surface 66, a third surface 70 extending between the first surface 62 and the second surface 66, a fourth surface 74, and a fifth surface 78. A socket 82 is formed in the first surface 62 and a pin 86 extends from the second surface 66. An aperture 90 extends through the first surface 62 and the second surface 66.

With continued reference to FIG. 2, the tube elbow 58 includes a plurality of channels 94 formed in the first surface 62. Each of the plurality of channels 94 is configured to at least partially receive a tube. In the illustrated embodiment, the tube elbow 58 includes three channels 94A, 94B, 94C formed in the first surface 62. Each of the plurality of channels 94 extends through the third surface 70 and the fifth surface 78. Each of the plurality of channels 94 has a span of approximately 90 degrees. In the illustrated embodiment, the channels 94B and 94C are positioned radially outward from the aperture 90.

With reference to FIG. 3, a tube elbow 98 illustrated is similar to the tube elbow 10 and is detailed herein with similar terminology where possible. The tube elbow 98 includes a first surface 102, a second surface 106, a third surface 110 extending between the first surface 102 and the second surface 106, and a fourth surface 114. In the illustrated embodiment, the fourth surface 114 is arcuate. In the illustrated embodiment, the tube elbow 98 is a half-circle shaped plate. A plurality of sockets 118 is formed in the first surface 102 and a plurality of pins 122 extend from the second surface 106. A plurality of apertures 126 extend through the first surface 102 and the second surface 106.

With continued reference to FIG. 3, the tube elbow 98 includes a channel 130 formed in the first surface 102, and the channel 130 is configured to at least partially receive a tube. The channel 130 is positioned between the plurality of apertures 126 and the plurality of sockets 118. In the illustrated embodiment, the channel 130 is arcuate and has a span of approximately 180 degrees. In some embodiments, the channel 130 has a span of less than 180 degrees. In some embodiments, the channel 130 has a span of greater than 180 degrees. In some embodiments, the channel 130 has a span in a range of from 90 degrees to 180 degrees. In the illustrated embodiment, the channel 130 extends through the third surface 110 at a first location 134 and at a second location 138 spaced apart from the first location 134. In some embodiments, the channel 130 has a span in a range of from 90 degrees to 180 degrees. The tube elbows disclosed herein may be customizable for a variety of channel spans and layouts.

With reference to FIG. 4, a tube elbow 142 illustrated is similar to the tube elbow 98 and is detailed herein with similar terminology where possible. The tube elbow 142 includes a first surface 146, a second surface 150, a third surface 154 extending between the first surface 146 and the second surface 150, and a fourth surface 158. A plurality of sockets 162 is formed in the first surface 146 and a plurality of pins 166 extend from the second surface 150. A plurality of apertures 170 extend through the first surface 146 and the second surface 150.

With continued reference to FIG. 4, the tube elbow 142 further includes a plurality of channels 174 formed in the first surface 146. Each of the plurality of channels 174 is configured to at least partially receive a tube. In the illustrated embodiment, the tube elbow 142 includes three channels 174A, 174B, 174C formed in the first surface 146. Each of the plurality of channels 174 extends through the third surface 154 at a first end 178 of the third surface 154 and at a second end 182 of the third surface 154, opposite the first end 178. Each of the plurality of channels 174 has a span of approximately 180 degrees. In the illustrated embodiment, the channels 174B and 174C are positioned radially outward from the plurality of apertures 170.

The tube elbows disclosed herein (e.g., tube elbows 10, 58, 98, 142) are made of materials suitable for exposure to radiation and strong acids. In some embodiments, the tube elbows 10, 58, 98 142 are made of polyether ether ketone (PEEK) or a similar radiation and chemically resistant polymer.

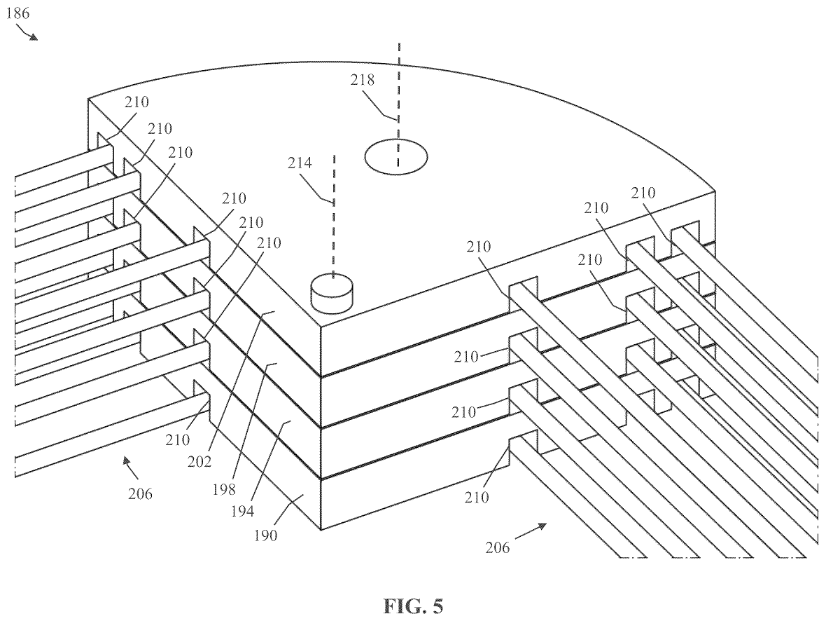

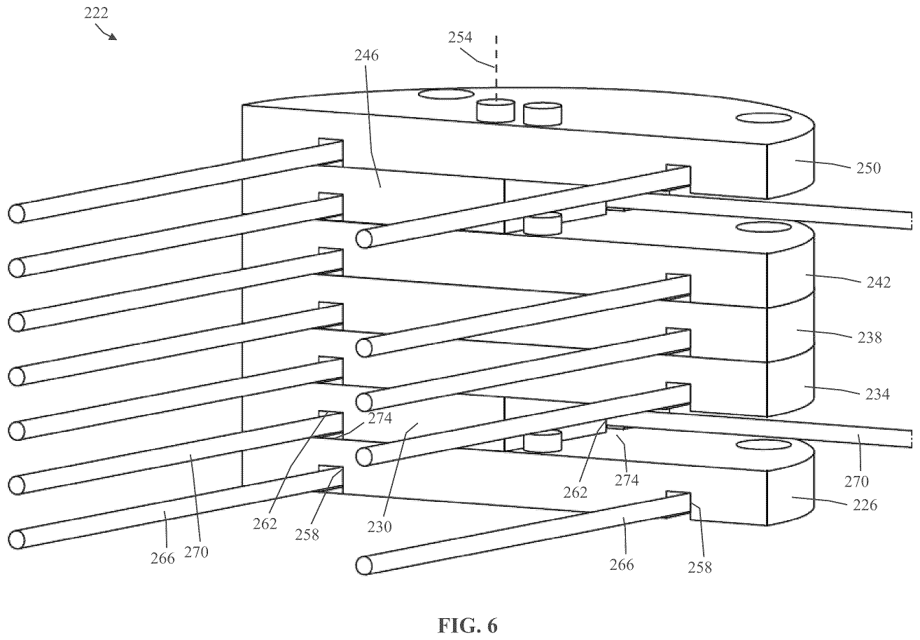

As detailed further herein, various combinations of the tube elbows 10, 58, 98, 142 are stacked together to form an assembly (e.g., FIG. 5, FIG. 6) of tube elbows. As such, the tube elbows 10, 58, 98, 142 provide a modular tube management system.

With reference to FIG. 5, an assembly 186 includes a first elbow 190, a second elbow 194, a third elbow 198, and a fourth elbow 202. In the illustrated embodiment, the elbows 190, 194, 198, 202 are all the same as the elbow 58 of FIG. 2. In other embodiments, the elbows in the assembly are not all the same (see, for example, FIG. 6). A plurality of tubes 206 is routed 90 degrees through each of the elbows 190, 194, 198, 202. In the illustrated embodiment, three tubes 206 are positioned within three channels 210 formed in each of the four elbows 190, 194, 198, 202 stacked together in the assembly 186.

With continued reference to FIG. 5, the first elbow 190, the second elbow 194, the third elbow 198, and the fourth elbow 202 are stacked along an axis 214. In the illustrated embodiment, the pin and socket of each of the elbows 190, 194, 198, 202 are aligned along the axis 214. In the illustrated embodiment, the second elbow 194 is positioned between the third elbow 198 and the first elbow 190. In the illustrated embodiment, the third elbow 198 is positioned between the fourth elbow 202 and the second elbow 194. The first elbow 190 includes a first pin (e.g., pin 86, FIG. 2) and the second elbow 194 includes a first socket (e.g., socket 82, FIG. 2). When assembled together in the assembly 186, the first pin is positioned within the first socket. Similarly, the second elbow 194 includes a second pin (e.g., pin 86, FIG. 2) and the third elbow 198 includes a second socket (e.g., socket 82, FIG. 2). Likewise, when assembled together in the assembly 186, the second pin is positioned within the second socket. Although the assembly 186 is shown with four elbows 190, 194, 198, 202 coupled together, in other embodiments the assembly includes two or more elbows coupled together.

With continued reference to FIG. 5, the elbows 190, 194, 198, 202 each have an aperture (e.g., aperture 90, FIG. 2) and the apertures are aligned along an aperture axis 218 when the elbows 190, 194, 198, 202 are stacked together in the assembly 186. In other words, the aperture axis 218 is co-axial with each of the aperture axis of the elbows 190, 194, 198, 202 in the assembly 186. The apertures aligned along the aperture axis 218 create a through hole in the assembly 186 that is configured to receive a fastener (e.g., a screw, a bolt, a clamp, etc.) to secure the assembly 186 to a surrounding workspace, such as a tabletop, for example.

With reference to FIG. 6, an assembly 222 includes a first elbow 226, a second elbow 230, a third elbow 234, and a fourth elbow 238, a fifth elbow 242, a sixth elbow 246, and a seventh elbow 250. The first elbow 226, the third elbow 234, the fourth elbow 238, the fifth elbow 242, and the seventh elbow 250 are the same as the elbow 98 of FIG. 3. The second elbow 230 and the sixth elbow 246 are the same as the elbow 10 of FIG. 1. As such, the assembly 222 includes different types of elbows stacked together along an axis 254. In the illustrated embodiment, at least one pin and socket for each of the elbows 226, 230, 234, 238, 242, 246, 250 are aligned along the axis 254.

With continued reference to FIG. 6, the first elbow 226 includes a first arcuate channel 258 formed therein. The second elbow 230 includes a second arcuate channel 262 formed therein. The first channel 258 is configured to at least partially receive a first tube 266, and the second channel 262 is configured to at least partially receive a second tube 270. In the illustrated embodiment, a surface 274 of the first elbow 226 (e.g., the second surface 106 of FIG. 3) at least partially encloses the second channel 262 in the second elbow 230. In other words, a channel formed in a tube elbow is partially covered by an adjacent tube elbow when the tube elbows are coupled together in an assembly.

In the illustrated embodiment, the first tube 266 is positioned in and routed 180 degrees through the first channel 258 of the first elbow 226. Likewise, the second tube 270 is positioned in and routed 90 degrees through the second channel 262 of the second elbow 230. As such, the first channel 258 has a first span (e.g., 180 degrees) and the second channel 262 has a second span (e.g., 90 degrees) that is different than the first span. In some embodiments, the first span and the second span are each in a range of from 90 degrees and 180 degrees and the first span is greater than the second span. In the illustrated embodiment, the second tube 270 is spaced from and parallel to the first tube 266. In some embodiments, the first tube 266 and the second tube 270 are polymer tubes.

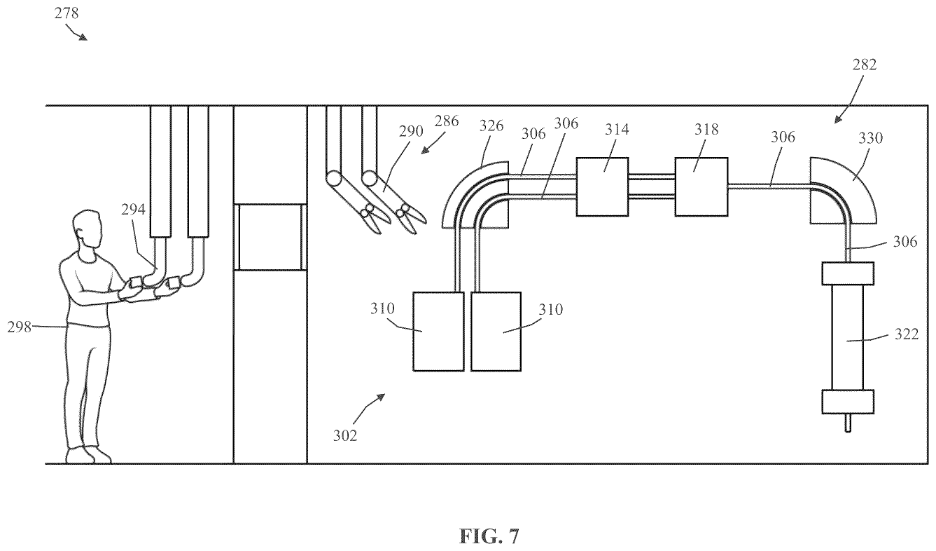

With reference to FIG. 7, a system 278 includes a hot cell 282 and a manipulator 286 at least partially positioned within the hot cell 282. The manipulator 286 includes a first portion 290 positioned within the hot cell 282 and a second portion 294 positioned outside of the hot cell 282. An operator 298 interacts with the second portion 294 to control movement and operation of the first portion 290 within the hot cell 282. The system 278 further includes a chromatography assembly 302 at least partially positioned within the hot cell 282. The chromatography assembly 302 includes a plurality of tubes 306 and any number of tanks 310, flasks, tubes, pumps 314 (e.g., fluid metering pumps), valves 318, columns 322 (high pressure liquid chromatography (HPLC) columns), or other similar chromatography equipment. In some embodiments, a radioisotope is present in the chromatography assembly. Acids, radioisotopes, and other solutions may be present in the chromatography assembly 302 and, in operation, the acids, radioisotopes, and other solutions may be directed though the tubing that is coupled to and managed by the tube elbows described herein.

With continued reference to FIG. 7, the system 278 includes a first tube elbow 326 and a second tube elbow 330 positioned within the hot cell 282. In some embodiments, the system 278 includes any number of tube elbows. At least one of the plurality of tubes 306 is coupled to the tube elbow 326 and the tube elbow 330. In the illustrated embodiment, two tubes 306 are coupled and routed 90 degrees through the tube elbow 326 and one tube 306 is coupled and routed 90 degrees through the tube elbow 330. In some embodiments, the first tube elbow 326 is part of a first assembly of tube elbows (e.g., assembly 186, assembly 222, etc.). As such, the tube elbows 326, 330 and the assemblies of tube elbows are configured for operation within a radiation hot cell.

As one example, the tube elbows disclosed herein are used for Radiopharmaceutical Production, which uses methods involving polymer tubing for process fluid and reagent transfer. If the polymer tubing is not restrained, the tubes create a cluttered mess that challenges the safe and effective operation of other hot cell components (e.g., hot cell manipulators). By securing the polymer tubes within channels to tube elbows and stacking two or more tube elbows together in a stack, the management and organization of the tubes is improved with clean 90-degree and 180-degree bends to route tubes as needed. In addition, with the use of mounting apertures, the assembled stacks of tube elbows can be secured to other structures within the hot cell environment to neatly route the tubing. Advantageously, the tube elbows 10, 58, 98, 142 provide a secure and mountable tube management system with no limit on how many tube lines can be secured within.

As another example, the tube elbows disclosed herein are used for benchtop fluidics and microfluidics work, which often involves the use of polymer tubing. Advantageously, the tube elbows and assemblies thereof, provide a modular system that adds structure and organization to polymer tubes.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, optical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A tube elbow comprising:
a first surface;
a second surface;
a third surface extending between the first surface and the second surface;
a channel formed in the first surface, the channel extends through the third surface;
a socket formed in the first surface; and
a pin extending from the second surface;
wherein the channel is configured to at least partially receive a tube.

2. The tube elbow of claim 1, wherein the channel is arcuate.

3. The tube elbow of claim 1, further comprising an aperture extending through the first surface and the second surface.

4. The tube elbow of claim 3, wherein the channel is positioned between the aperture and the socket.

5. The tube elbow of claim 1, further comprising a fourth surface extending between the first surface and the second surface; wherein the fourth surface is arcuate, and the third surface is planar.

6. The tube elbow of claim 1, wherein the channel is one of a plurality of channels formed in the first surface.

7. The tube elbow of claim 1, wherein the channel has a span in a range of from 90 degrees to 180 degrees.

8. The tube elbow of claim 7, further comprising a fourth surface extending between the first surface and the second surface; and a fifth surface extending between the first surface and the second surface, wherein the channel extends through the fifth surface.

9. The tube elbow of claim 1, wherein the channel has a span of 180 degrees and extends through the third surface at a first location and at a second location.

10. An assembly comprising:
a first elbow with a first channel formed therein;
a second elbow with a second channel formed therein; and
a third elbow;
wherein the first elbow, the second elbow, and the third elbow are stacked along an axis, and the second elbow is positioned between the third elbow and the first elbow;
wherein the first elbow includes a first pin, the second elbow includes a first socket, the first pin is positioned within the first socket;
wherein the second elbow includes a second pin, the third elbow includes a second socket, the second pin is positioned within the second socket; and
wherein the first channel is configured to at least partially receive a first tube and the second channel is configured to at least partially receive a second tube.

11. The assembly of claim 10, wherein the first channel is arcuate and the second channel is arcuate.

12. The assembly of claim 10, wherein the first channel has a first span and the second channel has a second span that is different than the first span and wherein the first span and the second span are each in a range of from 90 degrees and 180 degrees and the first span is greater than the second span.

13. The assembly of claim 10, further comprising a first tube at least partially positioned in the first channel and a second tube at least partially positioned in the second channel, and wherein the first tube is a polymer tube and the second tube is a polymer tube.

14. The assembly of claim 10, wherein the first channel is one of a first plurality of channels formed in the first elbow.

15. The assembly of claim 10, wherein a surface of the first elbow at least partially encloses the second channel in the second elbow.

16. The assembly of claim 10, wherein the first elbow includes a first aperture, the second elbow includes a second aperture, and the third aperture includes a third aperture; and wherein the first aperture, the second aperture, and the third aperture are aligned.

17. A system comprising:
a hot cell;
a manipulator at least partially positioned within the hot cell;
a chromatography assembly at least partially positioned within the hot cell, the chromatography assembly including a plurality of tubes; and
a tube elbow positioned within the hot cell, wherein at least one of the plurality of tubes is coupled to the tube elbow.

18. The system of claim 17, wherein the tube elbow comprises:
a first surface;
a second surface;
a third surface extending between the first surface and the second surface;
a channel formed in the first surface, the channel extends through the third surface;
a socket formed in the first surface; and
a pin extending from the second surface;
wherein the at least one of the plurality of tubes is nested in the channel.

19. The system of claim 17, wherein a radioisotope is present in the chromatography assembly.

20. The system of claim 17, wherein the tube elbow is a first tube elbow and the system further comprises a second tube elbow, and wherein at least one of the plurality of tubes is coupled to the tube elbow; and the second tube elbow is mounted on the first tube elbow.
